(19) United States
(12) Patent Application Publication
(10) Pub. No.: US 2016/0034990 A1
(43) Pub. Date: Feb. 4, 2016

(54) SYSTEM AND METHOD FOR SECURELY RETRIEVING PRIVATE DATA FROM CUSTOMER MOBILE DEVICE

(71) Applicant: Robert J. Kannair, Boston, MA (US)

(72) Inventor: Robert J. Kannair, Boston, MA (US)

(21) Appl. No.: 14/712,479

(22) Filed: May 14, 2015

Related U.S. Application Data
(60) Provisional application No. 62/031,545, filed on Jul. 31, 2014.

(51) Int. Cl. G06Q 30/06; H04L 29/06

(52) U.S. Cl. CPC G06Q 30/0609; H04L 63/083; H04L 63/04; H04L 63/0428; G06Q 2220/00

(57) ABSTRACT

A method and system for handling private user data in transactions between mobile devices and destination websites for e-commerce or other electronic transactions involving private user data. In particular, the present invention relates to a method and system for facilitating a secure transaction without requiring a user to login into the e-commerce website with a user name and password while allowing the user to maintain control over their personal information. In place of the traditional user login (e.g., user name and password) the login by the present invention occurs automatically by setting up a secure data channel between the e-commerce website and the mobile computing device utilizing an exchange server. The secure data channel may be created by exchanging private encryption keys (e.g., symmetric keys) between the destination website and the mobile computing device through the use of a secure data message exchange.

### CROSS-REFERENCE TO RELATED APPLICATION(S)

This application claims priority to, and the benefit of co-pending U.S. Provisional Application No. 62/031,545, filed Jul. 31, 2014, for all subject matter common to both applications. The disclosure of said provisional application is hereby incorporated by reference in its entirety.

### FIELD OF THE INVENTION

The present invention relates to secure transactions between computing devices. In particular, the present invention relates to a system and method for securely retrieving private user data, including payment transaction data, to facilitate a secure transaction, such as an e-commerce transaction, in a manner that overcomes a problem rooted in computer technology related to establishing secure wireless connections between computing devices.

### BACKGROUND

Generally, in order to facilitate a faster checkout process, e-commerce, and other transactional websites store customers' billing, shipping, payment, and other private data in central databases, e.g., within a cloud computing infrastructure (i.e., in the cloud). Since customers consider this data private, e-commerce websites regulate access to customer information by requiring authentication with a username and password to access the data. In addition to authentication, websites sometimes encrypt the data using a single private key held on the cloud-based website.

However, with these conventional e-commerce website database and cloud-based systems, users do not control their own private data stored in the database and cloud, nor do they possess the consolidated data comprising their own purchases across multiple different e-commerce websites, since the data resides in the database and cloud in association with different individual e-commerce websites. The process described above requires users to remember their username and password to complete e-commerce transactions while exposing them to the risk of data theft. If a malicious person steals either the user's username/password, or gains access to a website's database and/or cloud storage, then all user private data can be compromised. Since many users utilize the identical username/password combination on multiple websites, when one website is compromised, these security breaches can expose private date of a user on multiple different websites. Additionally, communications between user mobile devices and websites using public key encryption has proven vulnerable recently due to security exploits, such as Heartbleed.

### SUMMARY

There is a need for a system and method of handling private user data in transactions between mobile devices, and destination websites, such as for e-commerce or other electronic transactions involving private user data, in a manner that establishes a secure connection and protects private data. The present invention is directed toward further solutions to address this need, in addition to having other desirable characteristics. Specifically, the present invention creates a secure method for, e.g., e-commerce websites, to request and retrieve data from a user's mobile device (e.g., smartphone) upon explicit user approval. Utilizing this invention overcomes a problem rooted in computer technology related to establishing secure wireless connections between computing devices by eliminating the need for e-commerce websites to transmit via public key encryption, securely store, and authenticate access to users' private data. The invention facilitates e-commerce websites retrieving contact, shipping, promotion code, payment, and other required information from user smartphones to complete transactions. The invention secures the transmission of this private data using a transient, proprietary data transmission scheme passing encrypted data messages between the user's mobile devices and e-commerce websites. Since the solution can process transactions on multiple e-commerce websites from a user's mobile device, the system of the present invention creates a mobile device resident store of the user's transaction history across multiple e-commerce websites. The mobile device stored data can provide customer-centric aggregates of the totality of a user's purchase history to e-commerce websites, upon request from the websites, and approval from the user.

In accordance with an example embodiment of the present invention, a method is provided enabling an automatic login into an e-commerce website and establishing a secure path for exchanging data with a mobile computing device. The method includes sending a request, using a processor, to a distributed master server for a hostname of an issuer server to process a transaction. The method also includes receiving the hostname of the issuer server. The method further includes requesting, using a processor, a code for embedding the hostname of the issuer server, a domain address for the e-commerce website, and a randomly generated transaction ID for upcoming communications between the e-commerce website and the mobile computing device within the e-commerce website. The method includes receiving the requested code including the hostname of the issuer server, the domain address for the e-commerce website, and the randomly generated transaction ID. The method also includes modifying a login for the e-commerce website, using the requested code, by embedding the hostname of the issuer server, the domain address for the e-commerce website, and the randomly generated transaction ID into the e-commerce website to create the automatic login. The method further includes receiving a unique ID for the mobile computing device. The method also includes exchanging encrypted data payloads with the mobile computing device via the issuer server, thereby establishing the secure path.

According to aspects of the present invention, the hostname of the issuer server, the domain address for the e-commerce website, and the randomly generated transaction ID are embedded into the e-commerce website using a Software Development Kit (SDK). According to further aspects of the present invention, the hostname of the issuer server, the domain address for the e-commerce website, and the randomly generated transaction ID are embedded into the e-commerce website in the form of at least one of a Quick Response (QR) code and a button displayed on the e-commerce website. According to other aspects of the present invention, receiving the hostname of the issuer server is in response to the master server validating whether the e-commerce website as a valid domain.

According to aspects of the present invention, exchanging the encrypted data payloads further includes encrypting outgoing data payloads and decrypting incoming data payloads using a private key associated with the e-commerce website. According to further aspects of the present invention, the present invention includes receiving authorization and payment information for the mobile computing device, via the issuer server, processing transaction information for one or more purchases using the payment information, and sending confirmation and receipt of the processed transaction information to the mobile computing device, via the issuer server. According to other aspects of the present invention, exchanging the encrypted data payloads further includes transmitting transaction information for requesting authorization to process one or more purchases selected on the e-commerce website. According to aspects of the present invention, the present invention further includes receiving confirmation that the transaction for one or more purchases has been processed, via the issuer server and

In accordance with an example embodiment of the present invention, a method for automatically logging into an e-commerce website and implementing a transaction using a mobile computing device is provided. The method includes requesting initiation of a transaction with the e-commerce website. The method also includes receiving token information in response to the initiation request of the transaction. The method further includes sending a unique device ID associated with the mobile computing device and the token information to an issuer server to automatically login to the e-commerce website. The method also includes receiving a push message from the issuer server requesting approval of the transaction with the e-commerce website. The method further includes sending an indication of authorization of the transaction, including payment information to be used to complete the transaction.

According to aspects of the present invention, the token information can include the hostname of the issuer server and a transaction ID for upcoming communications between the e-commerce website and the mobile computing device. According to further aspects of the present invention, the hostname of the issuer server and the transaction ID are received in response to at least one of scanning a QR code displayed on the e-commerce website, an internal URL call initiated by pressing a button displayed in a mobile browser on the mobile computing device, and the internal URL call initiated by an e-commerce application on the mobile computing device associated with the e-commerce website. According to other aspects of the present invention, after a first QR code scan, the unique device ID for the mobile computing device is persisted on the e-commerce website, the mobile browser, or the e-commerce user mobile device application. According to aspects of the present invention, for subsequent transactions, the mobile computing device can initiate the transaction by a user selecting the button displayed on the e-commerce website. According to further aspects of the present invention, the receiving the push message and the sending the indication of authorization of the transaction further comprise encrypted data payloads using a private key of the mobile computing device. According to other aspects of the present invention, the payment information is stored on at least one of a data vault resident on the mobile computing data or a shared data vault connected to the issuer server. According to aspects of the present invention, the present invention further includes receiving confirmation and receipt of the payment information storing the confirmation and receipt of the payment information in the data vault 28 resident on the mobile computing device. According to further aspects of the present invention, the at least of one of a data vault comprise one or more shareable templates storing data for the payment information.

In accordance with an example embodiment of the present invention, a method of managing the secure transmission of data between an e-commerce website and a mobile computing device is provided. The method includes receiving an encrypted data message from a sending party, the data message having been encrypted using a private key of the sending party. The method also includes decrypting the encrypted data message using the private key of the sending party, resulting in an unencrypted data payload of the encrypted data message. The method further includes encrypting the unencrypted data payload to a newly encrypted data message with a private key of a recipient party. The method also includes sending the newly encrypted data message to the recipient party.

According to aspects of the present invention, the present invention further includes receiving the encrypted data message including transaction information for one or more purchases from the sending party, decrypting the encrypted data message using the private key of the sending party, encrypting the encrypted data message using the private key of the recipient, and pushing the data message to the recipient. According to further aspects of the present invention, the sending party is the e-commerce website and the recipient is the mobile computing device,

### BRIEF DESCRIPTION OF THE FIGURES

These and other characteristics of the present invention will be more fully understood by reference to the following detailed description in conjunction with the attached drawings, in which:

FIG. 1 is a diagrammatic illustration of the system and method architecture and methodology, according to one embodiment of the present invention;

FIG. 2 is an illustrative flowchart depicting the establishment of a secure login on an e-commerce website for creating a secure channel between the e-commerce website and a mobile computing device, in accordance with aspects of the invention;

FIG. 3 is an illustrative flowchart depicting a login process using a mobile computing device to facilitate a secure data transmission and persistence with an e-commerce website, in accordance with aspects of the invention;

FIG. 4 is an illustrative flowchart depicting utilizing an established secure data channel to exchange data between an e-commerce website and a mobile computing device, in accordance with aspects of the invention;

FIG. 5A is a graphical representations of the secure e-commerce transaction system, in accordance with aspects of the invention;

FIG. 5B is an illustrative flowchart depicting a login process using a mobile computing device to facilitate a secure data transmission with an e-commerce website, in accordance with aspects of the invention; and

FIG. 6 is a diagrammatic illustration of a high level architecture for implementing processes in accordance with aspects of the invention.

### DETAILED DESCRIPTION

An illustrative embodiment of the present invention relates to system and method for facilitating secure transactions between, an e-commerce website and a mobile computing device. In particular, the present invention relates to facilitating a secure transaction without requiring a user to login into the e-commerce website with a user name and password while allowing the user to maintain control over their personal information. In place of the traditional user login (e.g., user name and password) the login by the present invention occurs automatically by setting up a secure data channel between the e-commerce website and the mobile computing device utilizing an exchange server. The secure data channel may be created by exchanging private encryption keys (e.g., symmetric keys) between the e-commerce website and the mobile computing device through the use of a secure data message exchange protocol. For example, the login may be executed by using the mobile computing device to scan a Quick Response (QR) code displayed on an e-commerce website to automatically login and obtain the information needed to establish the secure data channel. Alternatively, the e-commerce website may be visited using an e-commerce application on the mobile computing device and upon detection of use of the application by the e-commerce website, a login button is presented for the login (e.g., in place of the traditional username password login). The login button may be displayed on the mobile computing device and selected by the user to automatically login to the e-commerce website. Similarly, the login may be executed by entering an introduction code displayed on the e-commerce website (e.g., displayed with the QR Code). For example, when the introduction code is entered the application may request the information needed to establish the secure data channel. In each embodiment, the exchange server operates in conjunction with the mobile computing device and the e-commerce website to facilitate a secure login.

Using the secure data channel established through the use of the exchange server, the user of the mobile device may share the user's payment information with the e-commerce website or the exchange server to process the payment. Advantageously, a user may perform a purchase transaction from an e-commerce website without the need of a traditional login and/or manually entering payment information directly into the e-commerce website. For example, the user may scan a QR Code on the e-commerce website causing a login to automatically occur and establish a secure data channel between the user's mobile computing device and the e-commerce website. Thereafter, the user may make a purchase and share payment information with the e-commerce website, through the use of the exchange server, such that the user maintains control over their own personal payment information.

The functionality of the present invention may be implemented by integrating a Software Development Kit (SDK) into the e-commerce website. For example, a domain SDK may be installed on the domain web server hosting the e-commerce website. Advantageously, the SDK provides webhosts with simple integration into existing e-commerce websites and other e-commerce applications. Similarly, the mobile computing device may integrate a mobile SDK through an e-commerce application running on the mobile device (e.g., an application for carrying out the transactions disclosed in the present invention). The SDKs expose the services of the exchange server for simple integration into existing e-commerce websites and/or mobile applications running on mobile computing devices. Accordingly, the SDKs may be used by the e-commerce website and/or mobile applications to enable login, checkout, payment, data persistence, and access in place of traditional username and password logins and other e-commerce website interfaces. As would be appreciated by one of skill in the art, the SDKs may also utilize server PHP or JavaServer Pages (JSP) packages and mobile iPhone and Android packages for implementation over Apple and Android computing devices.

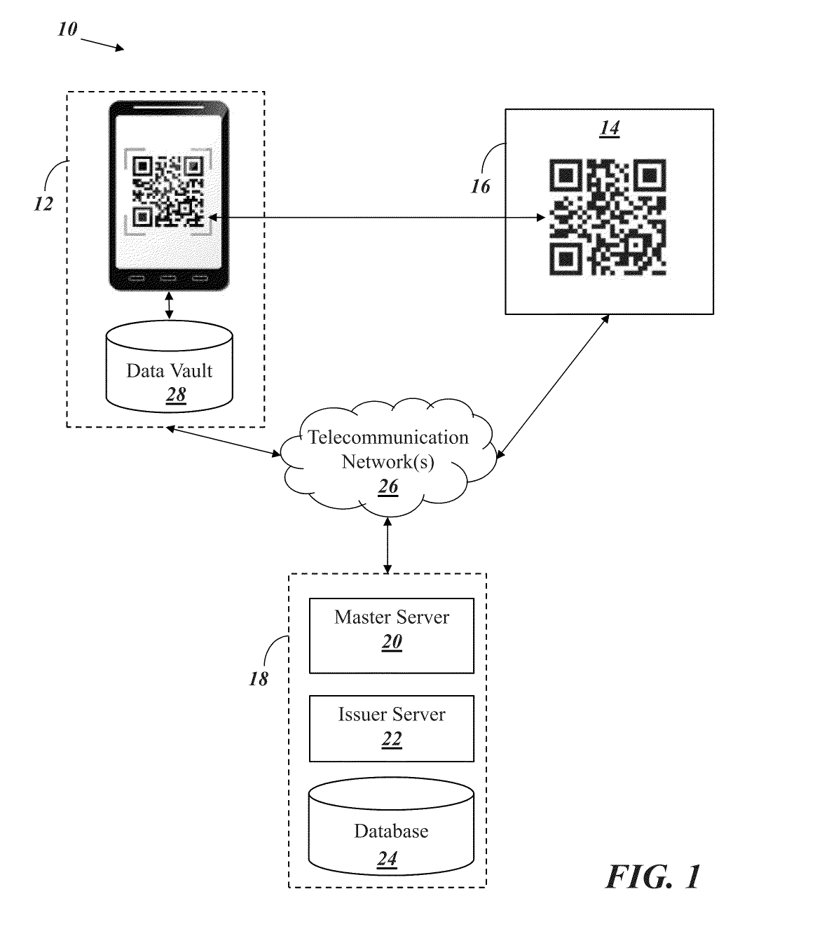

FIGS. 1 through 6, wherein like parts are designated by like reference numerals throughout, illustrate an example embodiment or embodiments of securely retrieving private user data, including payment transaction data, to facilitate a secure transaction, such as an e-commerce transaction, according to the present invention. Although the present invention will be described with reference to the example embodiment or embodiments illustrated in the figures, it should be understood that many alternative forms can embody the present invention. One of skill in the art will additionally appreciate different ways to alter the parameters of the embodiment(s) disclosed, in a manner still in keeping with the spirit and scope of the present invention.

FIG. 1 depicts a high level architecture of implementing processes in accordance with aspects of the present invention. Specifically, FIG. 1 depicts a computing system 10 including a mobile computing device 12. The mobile computing device 12 may be a general purpose computer or a specialized computer system. For example, the mobile computing device 12 may be a smartphone, a tablet, a laptop, personal digital assistant (PDA) or other mobile computing device 12. As would be appreciated by one of skill in the art, the present invention may be implemented using a non-mobile computing device, such as a desktop computer, laptop, etc. In accordance with an example embodiment of the present invention, the mobile computing device 12 may be configured to read and analyze various 2 dimensional and 3 dimensional barcode standards (e.g., Universal Product Code (UPC), Quick Response (QR) code, Stock Keeping Unit (SKU), etc.). In accordance with an example embodiment, the mobile computing device 12 is operable to scan a QR code 14 displayed on an e-commerce website 16. For example, the QR code 14 may be integrated into the e-commerce website 16 using a SDK installed on the domain web server for the e-commerce website 16. As would be appreciated by one of skill in the art, the mobile computing device 12 may include an e-commerce application for enabling the scanning of the QR code 14 and to facilitate other aspects of the present invention, as discussed with respect to FIGS. 1-6. For example, the e-commerce application may be SDK enabled application designed to carry out the functions of the present invention. As would be appreciated by one of skill in the art, the login interface on the e-commerce website 16 and the e-commerce application on the mobile computing device 12 may be implemented using an Application Program Interface (API).

In accordance with an example embodiment of the present invention, the high level architecture may include a secure exchange system 18 including or otherwise be connected to a master server 20, an issuer server 22 and a database 24. The secure exchange system 18 comprising the master server 20, the issuer server 22, and the database 24, may be a single computing device, a collection of computing devices in a network computing system, a cloud computing infrastructure, or a combination thereof, as would be appreciated by those of skill in the art. Similarly, the master server 20 and the issuer server 22 may be a single computing device, a collection of computing devices in a network computing system, a cloud computing infrastructure, or a combination thereof within the secure exchange system 18. The secure exchange system 18 may be configured to broker communications between the mobile computing device 12 and the e-commerce website 16 such that a secure data channel is created.

Continuing with FIG. 1, the master server 20 may be responsible for handling all administrative functions, and the issuer server 22 may be responsible for transactional functions. For example, the functions of the master server 20 may include device registration (e.g., registration of the mobile computing device 12), updates to the device registration, Google Cloud Messaging (GCM) registration, Access Point Name (APN) registration, support requests, and encryption reset requests. The functions of the issuer server 22 may include login authentication requests, Uniform Resource Language (URL) request, and payment authentication requests. Similarly, as would be appreciated to one of skill in the art, the database 24 may include any combination of computing devices configured to store and organize a collection of data. For example, the database 24 may be a local storage device in the secure exchange system 18, a remote database facility, or a cloud computing storage environment. The database 24 may also include a database management system utilizing a given database model configured to interact with a user for analyzing the database data.

In accordance with an example embodiment of the present invention, the mobile computing devices 12, e-commerce website 16, and the secure exchange system 18 may be configured to establish a secure data channel and communicate over telecommunication network(s) 26. As would be appreciated by one of skill in the art, the telecommunication network(s) 26 may include any combination of known networks. For example, the telecommunication network(s) 26 may be combination of a mobile network, WAN, LAN, or other type of network. The telecommunication network(s) 26 may be used to exchange data between the mobile computing device 12, and the e-commerce website 16, and the secure exchange system 18 to carry out the functions of the present invention. For example, the mobile computing devices 12 and e-commerce website 16 may use network 26 to exchange private keys with the secure exchange system 18 when establishing a secure data channel. Similarly, the telecommunication network(s) 26 may be used to exchange data between the mobile computing device 12 and the e-commerce website 16, via the secure exchange system 18. Accordingly, the secure data channel may be used to facilitate a login and the exchange of transactions between the user of the mobile computing device 12 and the e-commerce website 16 in accordance with the present invention.

Continuing with FIG. 1, the mobile computing device 12 and/or secure exchange system 18 may include an encrypted data vault 28 for storing personal and/or payment data for the user. In accordance with an example embodiment, encrypted data vault 28 may store data in various template formats including the user's contact, shipping, payment, and promo code information. For example, a contact template may include the user's first name, last name, a phone number, address, etc. A shipping template may include an indication of whether the user's address is commercial or residential. A credit card payment template may include a credit card number, the credit card expiration date, the credit card verification code (CVC), a billing street address, a billing city, a billing state, and a billing zip code. A promotion codes template may include numbers keyed to specific domains for obtaining promotional discounts on purchases from the domains. Each template may contain specific fields for particular categories, items, and values and may include an indication as to whether the specific fields are required or optional. As would be appreciated by one of skill in the art, additional templates may be created and/or added such that any other information desired to pass to the e-commerce website 16 for transaction processing may be included. Similarly, in addition to the templates, a user's private data may be stored in the encrypted data vault 28. For example, the data vault 28 may store a user's various usernames, passwords, order history, receipts, account numbers, etc. for various e-commerce websites. Advantageously, the present invention allows a user of the mobile computing device 12 to use a single mobile device to login to multiple e-commerce websites 16 without the need of multiple user name/password combinations. As would be appreciated by one of skill in the art, the data vault 28 may be stored locally on the mobile computing device 12 and/or may be a shared data vault 28 stored remotely on the secure exchange system 18 (e.g., stored in database 24). Accordingly, the private and payment information of the user may be stored on either the data vault 28 resident on the mobile computing device 12, remotely on the shared data vault 28 of the secure exchange system 18, or a combination thereof. For example, the templates may be stored remotely on the secure exchange system 18, while the private data may be stored on the data vault 28 resident on the mobile computing device 12. Accordingly, the user is able to maintain the private and/or payment data securely and separately from the e-commerce website(s) 16.

In accordance with an example embodiment of the present invention, the data within the templates may be shared upon a user's approval for a transaction. For example, a user may receive a request (e.g., from the issuer server 22) to share the information stored in one or more of the templates to complete a transaction for a purchase submitted by the user on the e-commerce website 16. As would be appreciated by one of skill in the art, the information in the data vault 28 may be imported or exported from the mobile computing device 12 or the secure exchange system 18, as instructed by the user. In accordance with an example embodiment, the information stored in the data vault 28 may be encrypted and may require a master username and password to share information from the data vault 28 with other parties (e.g., the e-commerce website 16). For example, the user may register their particular mobile computing device 12 to generate a private key may be used to encrypt the data stored within the data vault 28. Accordingly, only parties with the private key may access the vault data.

In operation, the computing system 10 may be used to login to an e-commerce website 16 and setup a secure data channel between the mobile computing device 12 and the e-commerce website 16 using private encryption keys. In particular, a private, secure data message exchange protocol is set up by using private keys to exchange messages between the e-commerce website 16 and the mobile computing device 12 via the secure exchange system 18. For example, the mobile computing device 12 may exchange messages with the e-commerce website 16, via the secure exchange system 18, using shared private keys for all message payloads. In accordance with an example embodiment of the present invention, the application associated with the inventive system on the mobile computing device 12 and the SDK running on the e-commerce website 16 include initial short lived transmission keys (large random number) for the first communication with the issuer server 22. For example, the mobile computing device 12 and the e-commerce website 16 SDK may start with a default key, which may also be known by the issuer server 22, to encrypt the first message to the issuer server 22. Thereafter, the mobile computing device 12 and the e-commerce website 16 may share their respective keys with the issuer server 22 to be used for any subsequent data exchanges. Accordingly, the short lived keys may be used by the issuer server 22 for encrypting communications between the issuer server 22 and the endpoints (the mobile computing device 12 and the e-commerce website 16). Advantageously, the keys are used to encrypt and decrypt all message payloads. As would be appreciated by one of skill in the art, the issuer server 22 may request the mobile computing device 12 and e-commerce website 16 use a new private key(s) at any time, such that all subsequent communications use the new private key(s). For example, the master server 20 may initiate a request to the mobile computing device and/or the e-commerce website 16 to change their respective private keys. In accordance with example embodiments of the present invention, the short lived key may not be used when storing data, instead, stored data may be secured using storage keys that the secure exchange system 18 manages.

Advantageously, the mobile computing device 12 and the e-commerce website 16 may use their respective private keys to pass data messages back and forth over the secure data channel via the issuer server 22 (within the secure exchange system 18) using a transaction ID to identify each particular conversation. The transaction ID may be a unique number that is generated each time the e-commerce website 16 requests an introduction (e.g., a QR code/Introduction code). The secure exchange system 18 uses the transaction ID to identify the current transaction. For example, the sending party encrypts (e.g., mobile computing device 12) a message with the sender private key, the sending party sends the encrypted message with the transaction ID to the issuer server 22, the issuer server 22 decrypts the message using the sender private key, the issuer server 22 encrypts the message with the recipient's private key, the issuer server 22 sends the encrypted message to the recipient (e.g., e-commerce website 16) with the transaction ID and a device ID, and the recipient receives and decrypts the message with the recipient's private key. Advantageously, using the secure data channel described herein, the e-commerce website 16 and mobile computing device 12 are bound together and are free to transmit commands and data between them to carry out transactions. As would be appreciated by one of skill in the art, the exchanged messages may include information related to verification of transactions, payments, or other functions carried out through the use of an e-commerce website.

As would be appreciated by one skilled in the art, the device ID may uniquely identify a mobile computing device 12 and the device's owner (e.g., the user of the mobile computing device 12). In accordance with example embodiments of the present invention, the device ID may be generated by the e-commerce application and sent to the master server 20 during registration. The device ID is used by the secure exchange system 18 to identify the mobile computing device 12. Advantageously, the secure exchange system 18 will be able to identify the mobile computing device 12 making or receiving other requests throughout the life of that mobile computing device 12. The secure exchange system 18 may use the device ID in conjunction with Transaction ID to identify and manage the secure pipe between the mobile computing device 12 and the e-commerce website 16 domain.

In accordance with an example embodiment of the present invention, the secure exchange system 18 may also be configured to perform various analytics of the encrypted data. Analytics packages on the secure exchange system 18 may be used to analyze exchanged encrypted message payloads from the mobile computing device 12 and e-commerce website 16 using the private keys to unlock data in a secure and controlled manner. The secure exchange system 18 may access and persist the user data included in the payloads from the shared data vault 28. For example, the secure exchange system 18 may accrue persisted data about the buying habits of users, transactional history, etc. Advantageously, the accrued data may be used to generate reports to give insight into the accrued data (e.g., a user's buying habits) without disclosing private user data. Similarly, analysis may be performed on the accrued data to indicate how similar products are doing across e-commerce website 16 domains. Advantageously, such analysis gives the e-commerce website 16 knowledge that will be useful in determining products to offer and optimal pricing for those products.

Additionally, the secure exchange system 18 may provide data reports of the persisted data to the mobile computing device 12 and the e-commerce website 16. For example, the mobile computing device 12 may send a report request using the private key to of the secure exchange system 18, the analytics packages may access the requested report data from storage (e.g., the shared data vault 28 on database 24) using the mobile computing device 12 private key and once accessed the requested report data may be returned to the mobile computing device 12. As would be appreciated by one of skill in the art, the same process may be carried out for requests from e-commerce website 16 using the e-commerce website 16 private key. In accordance with an example embodiment, the data stored in the shared data vault 28 may be set as private, shared, or a combination thereof by the user of the mobile computing device 12 and/or the e-commerce website 16. The analytics packages may run on the private and/or shared data by using the respective private key to unlock the data. For example, the analytics packages may use the e-commerce website 16 private key to unlock and analyze encrypted shopping cart data stored in the shared data vault 28. As would be appreciated by one of skill in the art, the respective encrypted data for the mobile computing device 12 and the e-commerce website 16 may be persisted and/or accessed on the shared data vault 28 (e.g., database 24) of the secure exchange system 18 using their respective private keys.

In accordance with an example embodiment of the present invention, in the event a user breaks or loses their mobile computing device 12, the present invention allows retrieval and backup of their personal vault from another user's mobile computing device 12. In particular, the e-commerce application may prompt the user with an indication as to whether the user would like to back up their personal vault data to another user's device. Upon authorization, an encrypted data file of the user's vault data is exported to the other user's mobile computing device 12, such that the user may access their data on the other user's mobile computing device 12. As would be appreciated by one of skill in the art, the e-commerce application requires a password to carry out the transfer for security purposes. Accordingly, in the event the user losses of breaks their mobile computing device 12, they may retrieve the encrypted backup from another user's device and unlock it with their password. Thereafter all the resulting data will be re-keyed with a new private key for the new mobile computing device 12.

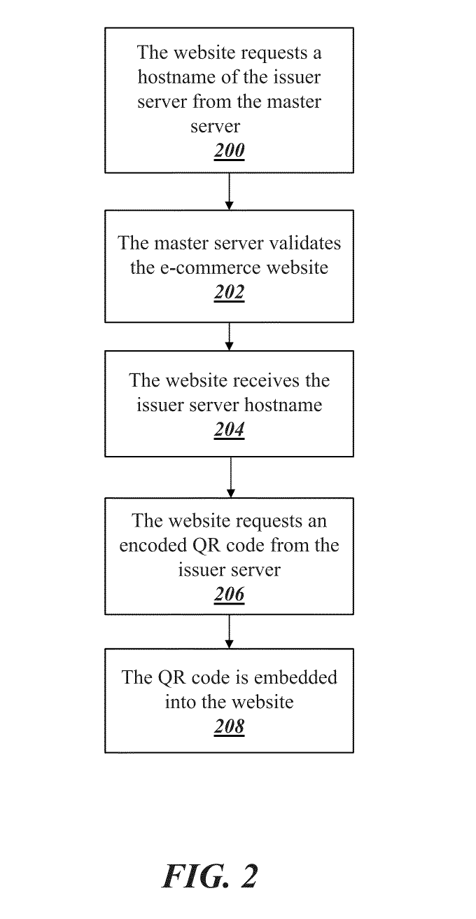

In accordance with the present invention, FIGS. 2-4 show exemplary flow charts depicting different operations that may be performed by the infrastructure depicted in FIG. 1 to carry out the functions of the claimed invention. In particular, FIG. 2 depicts establishing a secure login on the e-commerce website 16 for establishing a secure channel between the e-commerce website 16 or the domain for the e-commerce website 16 and the mobile computing device 12. At step 200, the e-commerce website 16 requests a hostname of the issuer server 22 for processing a transaction with the mobile computing device 12 from the master server 20. At step 202, the master server 20 validates whether the e-commerce website 16 is an approved domain. For example, the master server 20 may validate the e-commerce website 16 by determining whether the e-commerce website 16 is using an approve domain with a valid short lived transmission key (e.g., private key). As would be appreciated by one of skill in the art, an approve domain may be a domain previous authenticated within the secure exchange system 18 and/or satisfies a certain predetermined criteria. At step 204, after validation of the domain, the e-commerce website 16 may receive the issuer server 22 hostname.

At step 206, the e-commerce website 16 may request an introduction from the issuer server 22. The introduction may be used to initiate a login with a mobile computing device 12, and may be presented on the e-commerce website 16 in the form of an encoded QR code 14, an introduction code, or a button. In accordance with an example embodiment, the QR code 14 may include the hostname of the issuer server 22, a domain address for the e-commerce website 16, and a randomly generated transaction ID to be used for upcoming communications between the e-commerce website 16 and the mobile computing device 12. As would be appreciated by one of skill in the art, the process of obtaining the issuer hostname and the transaction ID is not intended to be limited to the use of the QR code 14. Additionally, an introduction code may be displayed on the e-commerce website 16 (e.g., in place of or in addition to the QR code) and may be entered by the user (e.g., on the e-commerce website 16 or on the e-commerce application) instead of scanning the QR code 14. For example, when a user enters the introduction code, the mobile computing device 12 may request the QR data payload (e.g., the hostname of the issuer server 22, a domain address for the e-commerce website 16, and a randomly generated transaction ID) from the issuer server 22.

In accordance with an example embodiment of the present invention, the issuer server 22 hostname and transaction ID may also be passed between a browser running on the mobile computing device 12 and the e-commerce application executing on the mobile computing device 12 via an internal URL call initiated by selecting a button in the browser on the mobile computing device 12. Similarly, the issuer server 22 hostname and transaction ID may also be passed between an e-commerce application running on the mobile computing device 12 and the application executing on the mobile computing device 12 via an internal URL call initiated by the e-commerce application running on the mobile computing device 12. As would be appreciated by one of skill in the art, the e-commerce website 16 may request the information needed to be embedded into the button displayed by the e-commerce website 16. At step 208, the QR code 14 (or button) is embedded into the e-commerce website 16. For example, the QR code 14, the introduction code and/or the button may be implemented into the e-commerce website 16 and displayed for the user using a SDK, as discussed with respect to FIG. 1.

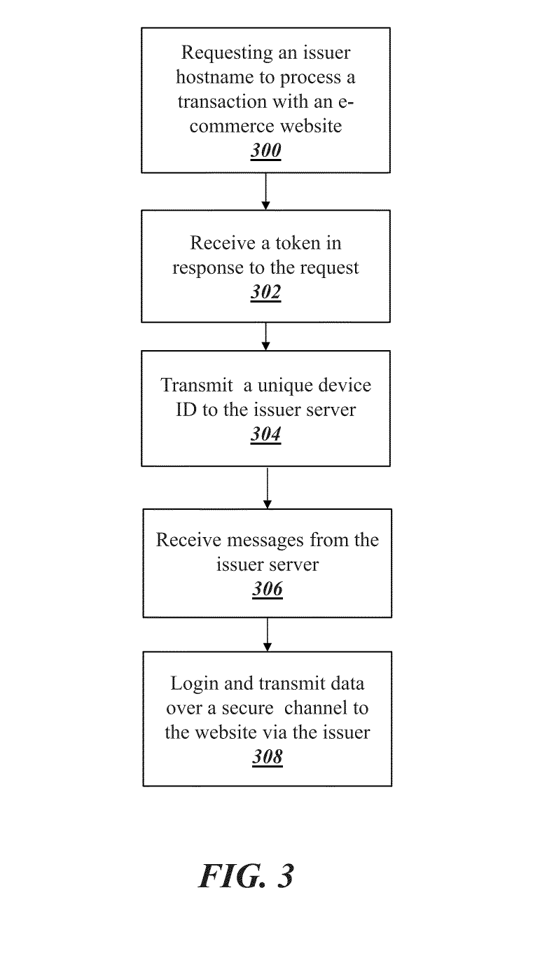

Once the e-commerce website 16 includes the introduction, in the form of the QR code 14, the introduction code and/or the button, then the introduction may be accessed by the mobile computing device 12. For example, the mobile computing device 12, executing the e-commerce application, may scan the QR code 14 (or enter the introduction code or select the button) displayed on an e-commerce website 16. Similarly, if the device has the e-commerce application of the present invention installed, the user may tap the QR code 14 or button displayed on the screen of the mobile computing device 12. For example, integration of SDK in the e-commerce website 16 detects the present of the e-commerce application on the mobile computing device 12. In response to detecting of the e-commerce application, the SDK on the e-commerce website 16 may display button to the user, such that the button provides the user with an automatic login. As would be appreciated by one of skill in the art, similar functionality may be implemented using a selectable button within the application itself. Accordingly, the user may scan the QR code, tap the QR code, enter the introduction code, or press the button displayed on the e-commerce website 16 to initiate calls to the issuer server 22 with the mobile computing device's 12 unique device ID. Advantageously, the scan, tap, code entry, or button click will initiate the automatically login process, as discussed in greater detail with respect to FIG. 3.

Thereafter, the issuer server 22 may send a mobile push message to the mobile computing device 12 to confirm/authentication the login and/or transaction. In response to the push message, the user of the mobile computing device 12 may accept or decline the login and/or authorization of a transaction contents. In accordance with example embodiments of the present invention, if the user scans the QR code 14, then the mobile computing device 12 may automatically send implicit authentication to the issuer server 22. Similarly, if the user enters the introduction code, the e-commerce application may request the same payload as is contained in the QR code from the master server 20. Upon receiving the QR payload the e-commerce application may send implicit authentication to the issuer server 22. After the user accepts the transaction, either expressly or implicitly, the data stored in the data vault 28 associated with mobile computing device 12 may be sent to the e-commerce website 16 for processing. As discussed with respect to FIG. 1, the data vault 28 may be a shared data vault 28 stored on the secure exchange system 18 or on a private storage resident in the mobile computing device 12. Upon acceptance, the customer is logged into the e-commerce website 16 and/or the transaction may be processed.

In particular, FIG. 3 depicts a login process using the mobile computing device 12, in accordance with the present invention, for facilitating secure data transmission and persistence between the e-commerce website 16 and the mobile computing device 12. At step 300, the mobile computing device 12, initiates a request for an issuer hostname (e.g., the issuer hostname of the issuer server 22) responsible for processing a transaction with the e-commerce website 16. For example, the mobile computing device 12 may initiate the request by scanning the QR code 14 displayed on the e-commerce website 16 with the e-commerce application associated with the present invention. In accordance with an example embodiment, as discussed with respect to FIGS. 1 and 2, the request may also be initiated by pressing a button displayed in a browser of the mobile computing device 12, entering an introduction code, or tapping the QR code 14. For example, pressing the button may activate an internal URL call for the issuer hostname for that particular transaction. Similarly, the request may also be initiated by an internal URL call initiated by the e-commerce application itself.

At step 302 the mobile computing device 12 receives or otherwise obtains a token in response to the request for the issuer hostname in step 300. For example, the mobile computing device 12 may receive or otherwise obtain the token from the scanning of the QR code 14 or the issuer server 22 may transmit the token to the mobile computing device 12 in response to a URL call. The token may include the information used for communicating with the e-commerce website 16 via the issuer server 22 for that particular transaction. For example, the token may include an issuer hostname (e.g., a URL prefix of the issuer server 22) and a transaction ID (e.g., the unique ID for the transaction generated by the secure exchange system 18 for the particular transaction). As would be appreciated by one of skill in the art, the issuer hostname and transaction ID may be encoded into the e-commerce website 16 via a SDK, as discussed with respect to FIG. 2. For example, the issuer hostname and transaction ID may be encoded in the QR code 14 on the e-commerce website 16 or within a button displayed on the e-commerce website 16.

At step 304, the mobile computing device 12 transmits the unique device ID associated with the received or otherwise obtained token to the issuer server 22. In accordance with an example embodiment of the present invention, the unique device ID is shared with the e-commerce website 16. For example, after scanning the QR code 14, the mobile computing device's 12 unique device ID is persisted on the e-commerce website 16, the mobile browser, or the e-commerce application via the issuer server 22. Accordingly, the unique device ID may be used by the e-commerce website 16 to identify the mobile computing device 12 when processing the transaction. In accordance with an example embodiment, subsequent transactions may be initiated by the mobile computing device 12 by pressing a button displayed on the e-commerce website 16 or e-commerce application without the need to scan the QR code 14 again once the unique device ID has been shared already.

At step 306 the mobile computing device 12 receives messages from the issuer server 22 including the secure protocol information needed to establish a secure data channel to carry out a secure transaction with the e-commerce website 16. Accordingly, the mobile computing device 12 and the e-commerce website 16 may freely exchange messages over the secure data channel. For example, the mobile computing device 12 may receive shopping cart information from the e-commerce website 16, via the issuer server 22. At step 308, in response to the message at step 306, the mobile computing device 12 may transmit secure data to the e-commerce website 16. For example, the mobile computing device 12 may send the user's payment information to the e-commerce website 16 via the issuer server 22. As would be appreciated by one of skill in the art, the mobile computing device 12 and the e-commerce website 16 may exchange multiple encrypted messages including various information via the issuer server 22 using their respective keys (e.g., as discussed with respect to FIG. 1) and the unique transaction ID for the particular transaction. Advantageously, the mobile computing device 12 and the e-commerce website 16 may use rotating keys to enable both ends of the data channel (e.g., the mobile computing device 12 side or the e-commerce website 16 side) to encrypt and decrypt one another's messages securely without using public key encryption technologies (e.g., Secure Sockets Layer (SSL) or Transport Layer Security (TLS)).

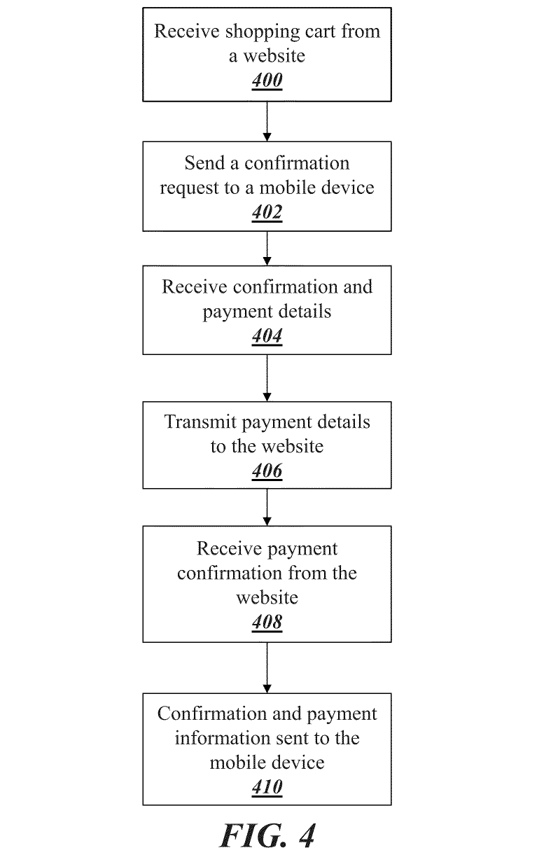

FIG. 4 depicts utilizing the established secure data channel, as discussed with respect to FIG. 3, such that a user may leverage the secure exchange system 18 to control the payment process between the mobile computing device 12 and the e-commerce website 16. For example, the secure data channel, as discussed with respect to FIGS. 1-3, may be used for performing a checkout process on the e-commerce website 16. At step 400, the issuer server 22 may receive transaction request information from the e-commerce website 16. For example, the e-commerce website 16 may request that the customer (e.g., the user of the mobile computing device 12) to review and approve and transaction and then share the resident private personal or payment information stored on the data vault 28 (e.g., the data vault 28 resident on the mobile computing device 12 or the shared data vault 28 stored remotely on the secure exchange system 18) to complete a transaction. As would be appreciated by one of skill in the art, the transaction may be a shopping cart order being “checked out” by the user of the mobile computing device 12 on the e-commerce website 16. At step 402, the issuer server 22 sends a push confirmation message including the transaction request to the mobile computing device 12 for review and approval by the user (e.g., consumer) on the mobile computing device 12.

At step 404, the issuer server 22 receives approval/confirmation of the requested transaction information from the mobile computing device 12 along with payment authorization. The payment authorization may include personal and payment information necessary for completing the transaction from the data vault 28. In accordance with an example embodiment of the present invention, the mobile computing device 12 may be used to select the payment information and/or form of payment for completing the transaction. For example, the consumer may select a payment template from the data vault 28 to be transmitted to the e-commerce website 16, via the issuer server 22, as discussed with respect to FIG. 1, and provide access to that payment information with the authorization. Alternatively, the issuer server 22 may receive indication of the user declining the transaction, thereby causing the e-commerce website 16 to not process the transaction and subsequently terminating the communication session.

At step 406, upon confirmation, the payment information may be processed using the received payment information. For example, the issuer server 22 transmits the payment information received from mobile computing device and/or the shared data vault 28 to the e-commerce website 16 for processing. Alternatively, in accordance with an example embodiment of the present invention, the issuer server 22 may process the payment for the transaction directly. At step 408, regardless of the processing party, the issuer server 22 receives payment confirmation from the e-commerce website 16. For example, the e-commerce website 16 sends a notification that payment for the transaction has been processed upon confirmation that the transaction cleared. At step 410, the issuer server 22 sends the confirmation and payment information to the mobile computing device 12. As would be appreciated by one of skill in the art, the messages exchanged between the mobile computing device 12, the e-commerce website 16, and the issuer server 22 are each encrypted using their respective private keys, as discussed with respect to FIGS. 1-3.

In accordance with an example embodiment of the present invention as depicted in FIG. 4, the consumer may also expose their private and/or payment data to the e-commerce website 16 to personalize the experience by unlocking their data on demand. Once a consumer initiates a transaction on an e-commerce website 16 (e.g., a shopping cart purchase), the e-commerce website 16 may send a personalization request to an analytics package on the secure exchange system 18 (step 400). The secure exchange system 18 may push the personalization request to the mobile computing device 12 for authorization to share the consumer's private data stored within the shared data vault 28 (e.g., on database 24) of the secure exchange system 18 (step 402). The mobile computing device 12 may approve/decline the transaction from the personalization request and transmit approval/disapproval with the mobile computing device 12 key to the analytics server (step 404). Upon receiving an indication of approval, the secure exchange system 18 may retrieve the consumer data from the shared data vault 28 and decrypt the data using the mobile computing device 12 private key. The secure exchange system 18 will encrypt the consumer data using the e-commerce website 16 and expose the data to the e-commerce website 16 (step 406). Thereafter, the e-commerce website 16 may use the exposed private and/or payment data to complete the transaction (step 408). Lastly, the issuer server 22 sends the confirmation and payment information to the mobile computing device 12 (step 410).

In accordance with an example embodiment of the present invention, the e-commerce website 16 persists transaction data (e.g., shopping cart data, payment confirmation, receipts, etc.) to the issuer server 22 (e.g., on database 24) for each e-commerce transaction, using the e-commerce website private key. Upon a successful transaction, the issuer server 22 persists the data using the private key provided by the e-commerce website 16 and deletes the customer's transaction data, thus eliminating any private data, which could otherwise be stolen via unauthorized access to the e-commerce website 16, or the like. As would be appreciated by one of skill in the art, domains for the e-commerce websites 16 may purge Personal Identity Information (PII), Payment Card Industry (PCI) data, and other transaction data to reduce the risk of the user's information being exploited. Advantageously, the data is shared from the data vault 28 without having to be stored by the e-commerce website 16. Accordingly, the de-identification and/or removal of the user's private and/or payment information ensures safe storage of e-commerce transactions on the secure exchange system 18 and the user “owns” their personal and payment information and controls which e-commerce websites 16 in which that data is shared.

Similarly, in accordance with an example embodiment of the present invention, upon a successful e-commerce transaction, the mobile computing device 12 stores the transaction details for the e-commerce website 16 in memory, thus accumulating the customer's e-commerce transaction history on their mobile computing device 12. In particular, the payment confirmation and receipts received from the e-commerce website 16, via push messages from the issuer server 22, may be stored in the data vault 28 resident on the mobile computing device 12. Accordingly, the mobile computing device 12 may store the transaction events for transactions (e.g., payment confirmation, receipts, etc.) across a multitude of e-commerce websites 16 on the user's personal data vault 28. Advantageously, the user may access transaction events spanning over a multitude of e-commerce websites 16 at a single location (e.g., the data vault 28 resident on the user's mobile computing device 12).

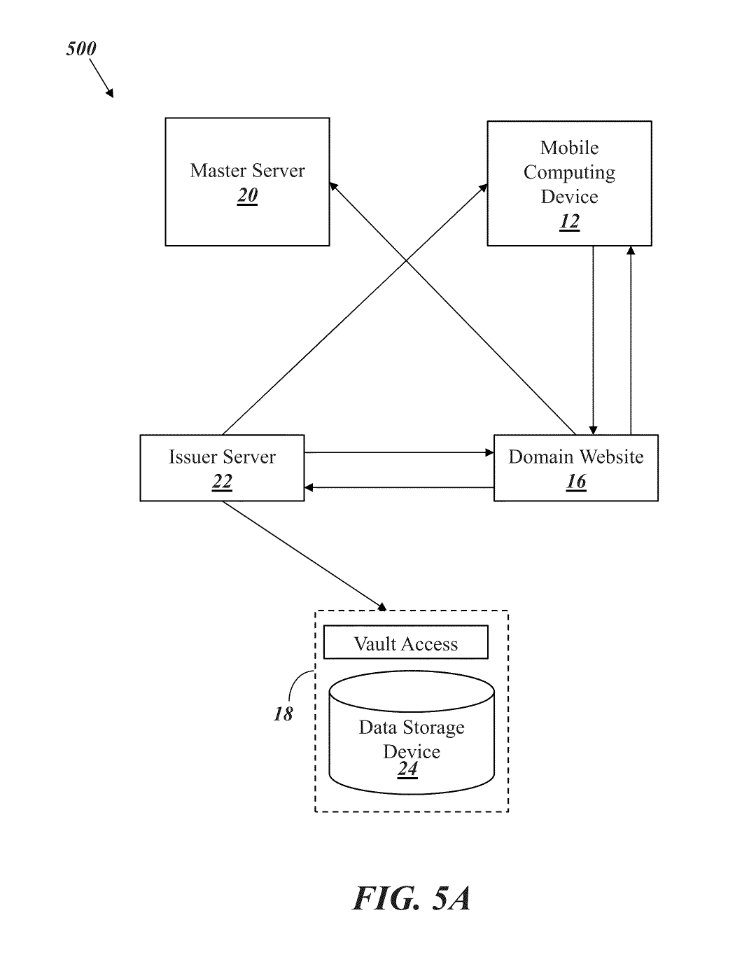

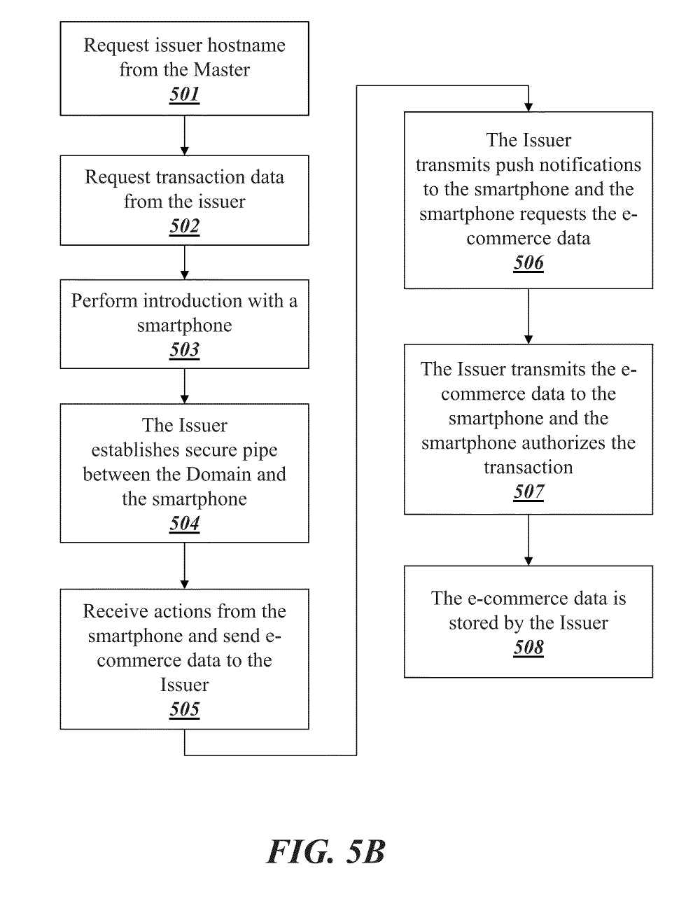

FIG. 5A illustrates an example embodiment or embodiments of a system and method for securely retrieving private data from a user's mobile device, according to the present invention. Although the present invention will be described with reference to the example embodiment or embodiments illustrated in the figures, it should be understood that many alternative forms can embody the present invention. One of skill in the art will additionally appreciate different ways to alter the parameters of the embodiment(s) disclosed, in a manner still in keeping with the spirit and scope of the present invention.

The present invention can be implemented in a number of different scenarios and for a number of different implementations requiring secure data transmission between a user's mobile device and a destination website. An example implementation is described herein in terms of a user being a customer, the user/customer's mobile device, and a remote destination website in the form of an e-commerce website with which the customer/user conducts a payment transaction for an online purchase. All references to “customer” herein are intended to be limited to “customer” users only for purposes of the illustrative example. Otherwise, customer is intended to refer to a “user” of the system, such that other implementations where a user is not a customer are anticipated for use with the present invention. Furthermore, the example device is referred to in the illustrative implementation as a “smartphone” but is not intended to be limited as such, but rather to include any device, mobile or otherwise, operable with the system and method of the present invention, as would be appreciated by those of skill in the art. Likewise, the “e-commerce website” is also intended only as a non-limiting example of a type of website that could leverage the technology offered by the present invention. As would be appreciated by one skilled in the art, additional types of websites, such as but not limited to, medical related websites, or other websites that deal with private and/or protected user information, are also considered for use in conjunction with the present invention.

Continuing with FIG. 5A, the figure depicts a high level architecture of implementing processes in accordance with aspects of the present invention. Specifically, FIG. 5A depicts a computing system 500 including a mobile computing device 12, an e-commerce website 16, a secure exchange system 18, a master server 20, an issuer server 22, and a database 24. For example, the mobile computing device 12, the e-commerce website 16, the secure exchange system 18, the master server 20, the issuer server 22, and the database 24, operate as discussed with respect to FIGS. 1-4. The communication paths depicted in FIG. 5A reflect the communication paths used when performing an automatic login and e-commerce transaction between a mobile computing device 12 and a domain webpage of an e-commerce website 16, in accordance with aspects of the present invention. In particular, FIG. 5A depicts an example e-commerce transaction as discussed in greater detail with respect to FIG. 5B.

FIG. 5B depicts the system 500 as discussed with respect to FIG. 5A in accordance with an example implementation of the present invitation. In particular, FIG. 5B depicts the use of the mobile computing device 12 (e.g., a smartphone), the e-commerce website 16 (e.g., a domain website), the issuer server 22 (e.g., issuer), a master server 20, (e.g., master), and a secure exchange system 18 including a database 24 (e.g., vault access to a data storage device 24). In step (501), when a user starts a web session with the domain website, the domain website sends a request to the master for the issuer hostname. In response to the request, at step (502), the domain website requests data needed for a new transaction from the issuer. The issuer transmits a unique transaction ID, an introduction QR code 14 and/or an introduction numeric code. After receiving the data, the e-commerce website 16 may display the QR code 14, the introduction numeric code, and/or the introduction button (e.g., the QR code 14, the introduction code, and the button discussed with respect to FIGS. 1-4) in the current user browser session. In accordance with an example implementation of the present invitation, an introduction button may be displayed if the user's web session is on the smartphone, the transaction data elements are transmitted to the domain. For example, the transaction ID and issuer hostname are transmitted to the domain, as discussed with respect to FIGS. 1, 2, and 5A.

At step (503), the user uses a smartphone app to perform an introduction between the ecommerce website 16 and the mobile computing device 12. As would be appreciated by one skilled in the art, the introduction may be performed by scanning the QR code 14, entering the numeric introduction code into the mobile computing device 12 app, or by pressing the introduction button. At step (504), the issuer establishes a secure pipe between the domain website (i.e., the e-commerce website 16) and the mobile computing device 12 for the current transaction, as discussed with respect to FIGS. 1-4. At step (505), when the user performs actions on the e-commerce website 16, the e-commerce website 16 will send e-commerce data to the issuer for delivery to the user's mobile computing device 12. For example, the e-commerce data may be the data associated with a user cart checkout, such as the products being purchased. At step (506), the issuer sends push notifications to the user's mobile computing device 12 to notify the user that the e-commerce data is available from the e-commerce website 16. In response, the mobile computing device 12 app will request the e-commerce data from the issuer. At step (507), the issuer sends the e-commerce data to the mobile computing device 12 in an encrypted format (e.g., using the key associated with the mobile computing device 12). As would be appreciated by one of skill in the art, each of the communications between the mobile computing device 12, the e-commerce website 16, and the issuer may be encrypted using their respective keys, as discussed with respect to FIGS. 1-4. The user may act upon the e-commerce data and send a response to the e-commerce website 16. For example, the user may authorize a transaction to purchase the items in the cart checkout. At step (508), issuer stores the e-commerce data in an encrypted format for later analysis (e.g., in data vault 28 as discussed with respect to FIGS. 1-4).

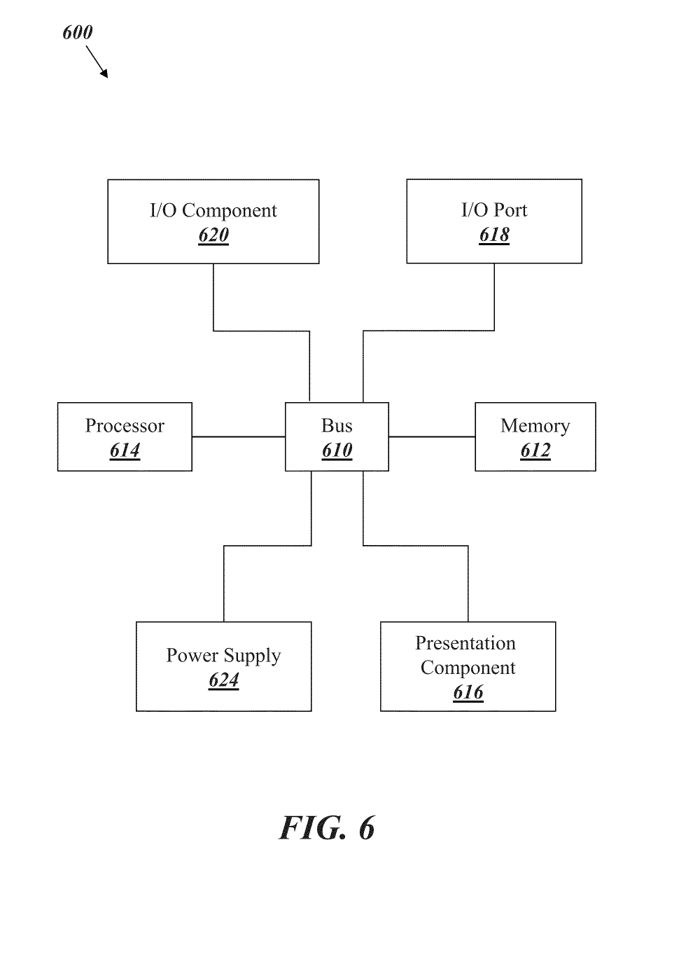

Any suitable computing device can be used to implement the computing devices 12, 22 (issuing server 22) and methods/functionality described herein. One illustrative example of such a computing device 600 is depicted in FIG. 6. The computing device 600 is merely an illustrative example of a suitable computing environment and in no way limits the scope of the present invention. A “computing device,” as represented by FIG. 6, can include a “workstation,” a “server,” a “laptop,” a “desktop,” a “hand-held device,” a “mobile device,” a “tablet computer,” or other computing devices, as would be understood by those of skill in the art. Given that the computing device 600 is depicted for illustrative purposes, embodiments of the present invention may utilize any number of computing devices 600 in any number of different ways to implement a single embodiment of the present invention. Accordingly, embodiments of the present invention are not limited to a single computing device 600, as would be appreciated by one with skill in the art, nor are they limited to a single type of implementation or configuration of the example computing device 600.

The computing device 600 can include a bus 610 that can be coupled to one or more of the following illustrative components, directly or indirectly: a memory 612, one or more processors 614, one or more presentation components 616, input/output ports 618, input/output components 620, and a power supply 624. One of skill in the art will appreciate that the bus 610 can include one or more busses, such as an address bus, a data bus, or any combination thereof. One of skill in the art additionally will appreciate that, depending on the intended applications and uses of a particular embodiment, multiple of these components can be implemented by a single device. Similarly, in some instances, a single component can be implemented by multiple devices. As such, FIG. 6 is merely illustrative of an exemplary computing device that can be used to implement one or more embodiments of the present invention, and in no way limits the invention.

The computing device 600 can include or interact with a variety of computer-readable media. For example, computer-readable media can include Random Access Memory (RAM); Read Only Memory (ROM); Electronically Erasable Programmable Read Only Memory (EEPROM); flash memory or other memory technologies; CDROM, digital versatile disks (DVD) or other optical or holographic media; magnetic cassettes, magnetic tape, magnetic disk storage or other magnetic storage devices that can be used to encode information and can be accessed by the computing device 600.

The memory 612 can include computer-storage media in the form of volatile and/or nonvolatile memory. The memory 612 may be removable, non-removable, or any combination thereof. Exemplary hardware devices are devices such as hard drives, solid-state memory, optical-disc drives, and the like. The computing device 600 can include one or more processors that read data from components such as the memory 612, the various I/O components 616, etc. Presentation component(s) 616 present data indications to a user or other device. Exemplary presentation components include a display device, speaker, printing component, vibrating component, etc.

The I/O ports 618 can enable the computing device 600 to be logically coupled to other devices, such as I/O components 620. Some of the I/O components 620 can be built into the computing device 600. Examples of such I/O components 620 include a microphone, joystick, recording device, game pad, satellite dish, seamier, printer, wireless device, networking device, and the like.

As utilized herein, the terms “comprises” and “comprising” are intended to be construed as being inclusive, not exclusive. As utilized herein, the terms “exemplary”, “example”, and “illustrative”, are intended to mean “serving as an example, instance, or illustration” and should not be construed as indicating, or not indicating, a preferred or advantageous configuration relative to other configurations. As utilized herein, the terms “about” and “approximately” are intended to cover variations that may existing in the upper and lower limits of the ranges of subjective or objective values, such as variations in properties, parameters, sizes, and dimensions. In one non-limiting example, the terms “about” and “approximately” mean at, or plus 10 percent or less, or minus 10 percent or less. In one non-limiting example, the terms “about” and “approximately” mean sufficiently close to be deemed by one of skill in the art in the relevant field to be included. As utilized herein, the term “substantially” refers to the complete or nearly complete extend or degree of an action, characteristic, property, state, structure, item, or result, as would be appreciated by one of skill in the art. For example, an object that is “substantially” circular would mean that the object is either completely a circle to mathematically determinable limits, or nearly a circle as would be recognized or understood by one of skill in the art. The exact allowable degree of deviation from absolute completeness may in some instances depend on the specific context. However, in general, the nearness of completion will be so as to have the same overall result as if absolute and total completion were achieved or obtained. The use of “substantially” is equally applicable when utilized in a negative connotation to refer to the complete or near complete lack of an action, characteristic, property, state, structure, item, or result, as would be appreciated by one of skill in the art.

Numerous modifications and alternative embodiments of the present invention will be apparent to those skilled in the art in view of the foregoing description. Accordingly, this description is to be construed as illustrative only and is for the purpose of teaching those skilled in the art the best mode for carrying out the present invention. Details of the structure may vary substantially without departing from the spirit of the present invention, and exclusive use of all modifications that come within the scope of the appended claims is reserved. Within this specification embodiments have been described in a way which enables a clear and concise specification to be written, but it is intended and will be appreciated that embodiments may be variously combined or separated without parting from the invention. It is intended that the present invention be limited only to the extent required by the appended claims and the applicable rules of law.

It is also to be understood that the following claims are to cover all generic and specific features of the invention described herein, and all statements of the scope of the invention which, as a matter of language, might be said to fall therebetween.

What is claimed is:

1. A method for enabling an automatic login into an e-commerce website and establishing a secure path for exchanging data with a mobile computing device, the method comprising:
sending a request, using a processor, to a distributed master server for a hostname of an issuer server to process a transaction;
receiving the hostname of the issuer server;
requesting, using a processor, a code for embedding the hostname of the issuer server, a domain address for the e-commerce website, and a randomly generated transaction ID for upcoming communications between the e-commerce website and the mobile computing device within the e-commerce website;
receiving the requested code including the hostname of the issuer server, the domain address for the e-commerce website, and the randomly generated transaction ID;
modifying a login for the e-commerce website, using the requested code, by embedding the hostname of the issuer server, the domain address for the e-commerce website, and the randomly generated transaction ID into the e-commerce website to create the automatic login;
receiving a unique ID for the mobile computing device; and
exchanging encrypted data payloads with the mobile computing device via the issuer server, thereby establishing the secure path.

2. The method of claim 1, wherein the hostname of the issuer server, the domain address for the e-commerce website, and the randomly generated transaction ID are embedded into the e-commerce website using a Software Development Kit (SDK).

3. The method of claim 2, wherein the hostname of the issuer server, the domain address for the e-commerce website, and the randomly generated transaction ID are embedded into the e-commerce website in the form of at least one of a Quick Response (QR) code and a button displayed on the e-commerce website.

4. The method of claim 1, wherein receiving the hostname of the issuer server is in response to the distributed master server validating whether the e-commerce website as a valid domain.

5. The method of claim 1, wherein the exchanging the encrypted data payloads further comprises encrypting outgoing data payloads and decrypting incoming data payloads using a private key associated with the e-commerce website.

6. The method of claim 5, further comprising:
receiving authorization and payment information for the mobile computing device, via the issuer server;
processing transaction information for one or more purchases using the payment information; and
sending confirmation and receipt of the processed transaction information to the mobile computing device, via the issuer server.

7. The method of claim 1, wherein the exchanging the encrypted data payloads further comprises transmitting transaction information for requesting authorization to process one or more purchases selected on the e-commerce website.

8. The method of claim 5, further comprising:
receiving confirmation that the transaction for one or more purchases has been processed, via the issuer server; and
sending confirmation and receipt of the processed transaction information to the mobile computing device, via the issuer server.

9. A method for automatically logging into an e-commerce website and implementing a transaction using a mobile computing device, the method comprising:
requesting initiation of a transaction with the e-commerce website;
receiving token information in response to the initiation request of the transaction;
sending a unique device ID associated with the mobile computing device and the token information to an issuer server to automatically login to the e-commerce website;
receiving a push message from the issuer server requesting approval of the transaction with the e-commerce website; and
sending an indication of authorization of the transaction, including payment information to be used to complete the transaction.

10. The method of claim 9, wherein the token information comprises the hostname of the issuer server and a transaction ID for upcoming communications between the e-commerce website and the mobile computing device.

11. The method of claim 10, wherein the hostname of the issuer server and the transaction ID are received in response to at least one of scanning a QR code displayed on the e-commerce website, an internal URL call initiated by pressing a button displayed in a mobile browser on the mobile computing device, and the internal URL call initiated by an e-commerce application on the mobile computing device associated with the e-commerce website.

12. The method of claim 11, wherein after a first QR code scan, the unique device ID for the mobile computing device is persisted on the e-commerce website, the mobile browser, or an e-commerce user mobile device application.

13. The method of claim 12, wherein for subsequent transactions, the mobile computing device can initiate the transaction by a user selecting the button displayed on the e-commerce website.

14. The method of claim 9, wherein the receiving the push message and the sending the indication of authorization of the transaction further comprise encrypted data payloads using a private key of the mobile computing device.

15. The method of claim 9, wherein the payment information is stored on at least one of a data vault resident on the mobile computing data or a shared data vault connected to the issuer server.

16. The method of claim 15, further comprising:
receiving confirmation and receipt of the payment information; and
storing the confirmation and receipt of the payment information in the data vault resident on the mobile computing device.

17. The method of claim 15, wherein the at least of one of a data vault comprise one or more shareable templates storing data for the payment information.

18. A method of managing the secure transmission of data between an e-commerce website and a mobile computing device, the method comprising:
receiving an encrypted data message from a sending party, the encrypted data message having been encrypted using a private key of the sending party;
decrypting the encrypted data message using the private key of the sending party, resulting in an unencrypted data payload of the encrypted data message;
encrypting the unencrypted data payload to a newly encrypted data message with a private key of a recipient party; and
sending the newly encrypted data message to the recipient party.

19. The method of claim 18, further comprising:
receiving the encrypted data message including transaction information for one or more purchases from the sending party;
decrypting the encrypted data message using the private key of the sending party;
encrypting the encrypted data message using the private key of the recipient; and
pushing the encrypted data message to the recipient.

20. The method of claim 18, wherein the sending party is the e-commerce website and the recipient is the mobile computing device.
